(19) United States
(12) Patent Application Publication
(10) Pub. No.: US 2015/0273633 A1
(43) Pub. Date: Oct. 1, 2015

(54) THERMAL CUTTING MACHINE

(71) Applicant: KOMATSU INDUSTRIES CORPORATION, Kanazawa-shi, Ishikawa (JP)

(72) Inventors: Koji Masauji, Kanazawa-shi (JP); Masahiko Ookubo, Hakui-gun (JP); Seiichi Hayashi, Komatsu-shi (JP)

(21) Appl. No.: 14/434,539

(22) PCT Filed: Oct. 16, 2013
(86) PCT No.: PCT/JP2013/078069

§ 371 Date: Apr. 9, 2015

(30) Foreign Application Priority Data
Oct. 26, 2012 (JP) 2012-237306

(51) Int. Cl. B23K 26/38; B23Q 7/00; B23K 26/30

(52) U.S. Cl. CPC B23K 26/38; B23K 26/422; B23Q 7/00

(57) ABSTRACT

There is provided a laser processing machine that performs laser processing by emitting laser beams onto a workpiece on a pallet, wherein a gull wing is provided on a front surface of a cabin that houses a processing head for emitting the laser beams and a pallet drive mechanism, and a loading/unloading port for loading the pallet into the cabin or unloading the pallet from the cabin is provided on a rear surface of the cabin. The pallet drive mechanism can drive the pallet to a pallet drawn-out position that is closer to the front surface side than a processing time placement position of the pallet at the time of laser processing.

### TECHNICAL FIELD

The present invention relates to a thermal cutting machine such as a laser processing machine, a plasma processing machine and a gas cutting machine, and more specifically to a thermal cutting processing machine that can be adapted to a small-lot product as well and can achieve efficient processing.

### BACKGROUND ART

As one example of a thermal cutting machine, a laser processing machine has a processing head housed in a cabin in order to protect an operator and the like from laser beams. Disclosed as a conventional laser processing machine is a laser processing machine including a cabin body for covering an upper part of a laser processing machine body and a processing table, and a sub-cabin formed of a plurality of divided covers and arranged below the cabin body in a vertically movable manner to cover a periphery of the processing table (refer to, for example, PTD 1).

Also disclosed is a laser processing machine including an upper cabin and a lower cabin, the upper cabin being formed of a fixed cabin and a self-standing cover that faces the fixed cabin and enclosing an upper part of the apparatus, and the lower cabin supporting the upper cabin such that the upper cabin can be moved up and down and enclosing a lower part of the apparatus (refer to, for example, PTD 2).

### CITATION LIST

### Patent Document

PTD 1: Japanese Patent Laying-Open No. 8-206870

PTD 2: Japanese Patent No. 4671697

### SUMMARY OF INVENTION

### Technical Problem

In the case where a processing machine body is covered with a cabin, it is common to place a pallet changer and the like adjacent to the processing machine body, to receive and deliver a workpiece outside the cabin that covers the processing machine body, and to perform the loading/unloading operation. Therefore, even in the case of processing of a small-lot product and a small-sized product, the pallet replacement work using a large-sized pallet changer is required, which has been problematic from the viewpoint of work efficiency. In the laser processing machine described in PTD 1, loading and unloading of a workpiece by a pallet is not taken into consideration. In the laser processing machine described in PTD 2, loading and unloading by a crane for processing of a large-sized product is taken into consideration, while loading and unloading of a small-sized product is not taken into consideration. In addition, when a cover of a laser processing machine is opened to access a workpiece located in a processing machine body, the work in an uncomfortable waist-bent posture is required, which has resulted in an increase in burden imposed on the operator.

The present invention has been made in light of the aforementioned problems and an object of the present invention is to provide a thermal cutting machine that can be adapted to not only processing of a large-lot product but also processing of a small-lot product, can reduce a burden on an operator, and can achieve efficient processing.

### Solution to Problem

The aforementioned object of the present invention is achieved by the configurations described below.

Specifically, the invention according to claim 1 is directed to a thermal cutting machine that thermally cuts a workpiece on a pallet, including:

a processing head for allowing a workpiece to generate heat;

a cabin for housing the processing head;

a pallet on which the workpiece is placed; and

a pallet drive mechanism for driving the pallet in a prescribed direction, wherein

an open/close door is provided on a first surface of the cabin, and

a loading/unloading port for loading the pallet into the cabin or unloading the pallet from the cabin is provided on a second surface of the cabin located on an opposite side of the first surface in the prescribed direction.

The invention of claim 2 is characterized in that in the configuration of claim 1, the pallet drive mechanism can drive the pallet to a pallet drawn-out position that is closer to the first surface side than a processing time placement position of the pallet at the time of the processing.

The invention of claim 3 is characterized in that in the configuration of claim 2, the pallet drive mechanism can drive the pallet in response to opening and closing of the open/close door, and the pallet drive mechanism moves the pallet to the pallet drawn-out position when the open/close door is opened, and moves the pallet to the processing time placement position when the open/close door is closed.

The invention of claim 4 is characterized in that in the configuration of any one of claims 1 to 3, the cabin is provided with a first control panel arranged on the first surface and arranged lateral to the open/close door, and a second control panel arranged on a third surface orthogonal to the first surface and the second surface and arranged closer to the second surface.

The invention of claim 5 is characterized in that in the configuration of any one of claims 1 to 4, a foot switch that is arranged below the open/close door and can be foot-operated by an operator is further provided, wherein the foot switch is operated at the time of an opening operation of the open/close door.

The invention of claim 6 is characterized in that in the configuration of any one of claims 1 to 5, the open/close door is a gull wing that upwardly pivots about a pivot point provided on a ceiling of the cabin.

The invention of claim 7 is characterized in that in the configuration of any one of claims 1 to 6, notifying means for, at the time of at least one of an opening operation and a closing operation of the open/close door, notifying an operator of the operation by light or sound is further provided.

### Advantageous Effects of Invention

According to claim 1, the open/close door is provided on the first surface of the cabin, and the loading/unloading port is provided on the second surface of the cabin. Therefore, at the time of processing of a large-lot product, the pallet having the workpiece placed thereon is loaded and unloaded through the loading/unloading port, and at the time of processing of a small-lot product, the workpiece is loaded and unloaded from the open/close door. Thus, the loading/unloading work is performed in accordance with the lot size. As a result, a burden on the operator can be reduced and efficient processing can be achieved.

According to claim 2, the pallet drive mechanism can drive the pallet to the pallet drawn-out position that is closer to the open/close door side than the processing time placement position. Therefore, when a small-lot product is loaded and unloaded from the open/close door, the work can be easily performed in a comfortable posture and a burden on the operator can be reduced.

According to claim 3, the pallet drive mechanism drives the pallet in response to opening and closing of the open/close door, and the pallet drive mechanism moves the pallet to the pallet drawn-out position when the open/close door is opened, and moves the pallet to the processing time placement position when the open/close door is closed. Therefore, the loading/unloading work from the open/close door can be easily performed.

According to claim 4, the cabin is provided with the first control panel arranged on the first surface and arranged lateral to the open/close door, and the second control panel arranged on the third surface and arranged closer to the second surface.

Therefore, in accordance with whether the small-lot work on the open/close door side or the large-lot work on the loading/unloading port side is performed, the closer control panel can be used. Thus, a movement distance of the operator can be minimized and efficient processing can be achieved.

According to claim 5, the foot switch that is arranged below the open/close door and can be foot-operated by the operator is further provided, and the foot switch is operated at the time of the opening operation of the open/close door. Therefore, even with the operator's hands full, the open/close door can be opened to perform the work, and thus, the work efficiency is improved.

According to claim 6, the open/close door is the gull wing that upwardly pivots about the pivot point provided on the ceiling of the cabin. Therefore, an amount of forward protrusion along an open/close door movement path when opening and closing the open/close door is reduced, and the open/close door can be opened and closed safely. In addition, a space for placing the thermal cutting machine can be reduced.

According to claim 7, the notifying means for, at the time of at least one of the opening operation and the closing operation of the open/close door, notifying the operator of the operation by light or sound is further provided. Therefore, the operation of the open/close door can be performed more safely.

### BRIEF DESCRIPTION OF DRAWINGS

FIG. 1 is a schematic plan view of a laser processing machine according to one embodiment of the present invention.

FIG. 2 is a schematic side view of the laser processing machine shown in FIG. 1.

FIG. 3 is a perspective view of a processing head drive mechanism.

FIG. 4 is a perspective view of a processing head.

FIG. 5 is a back view of the laser processing machine shown in FIG. 1.

FIG. 6 is a perspective view of a processing machine body shown in FIG. 1.

FIG. 7 is an enlarged view for describing a relationship between opening and closing of an open/close door and a position of a pallet.

FIG. 8(a) is a process chart showing a work process using a pallet changer and

FIG. 8(b) is a process chart showing a work process using the open/close door.

### DESCRIPTION OF EMBODIMENTS

As one example of a thermal cutting machine according to the present invention, one embodiment of a laser processing machine will be hereinafter described in detail with reference to the drawings.

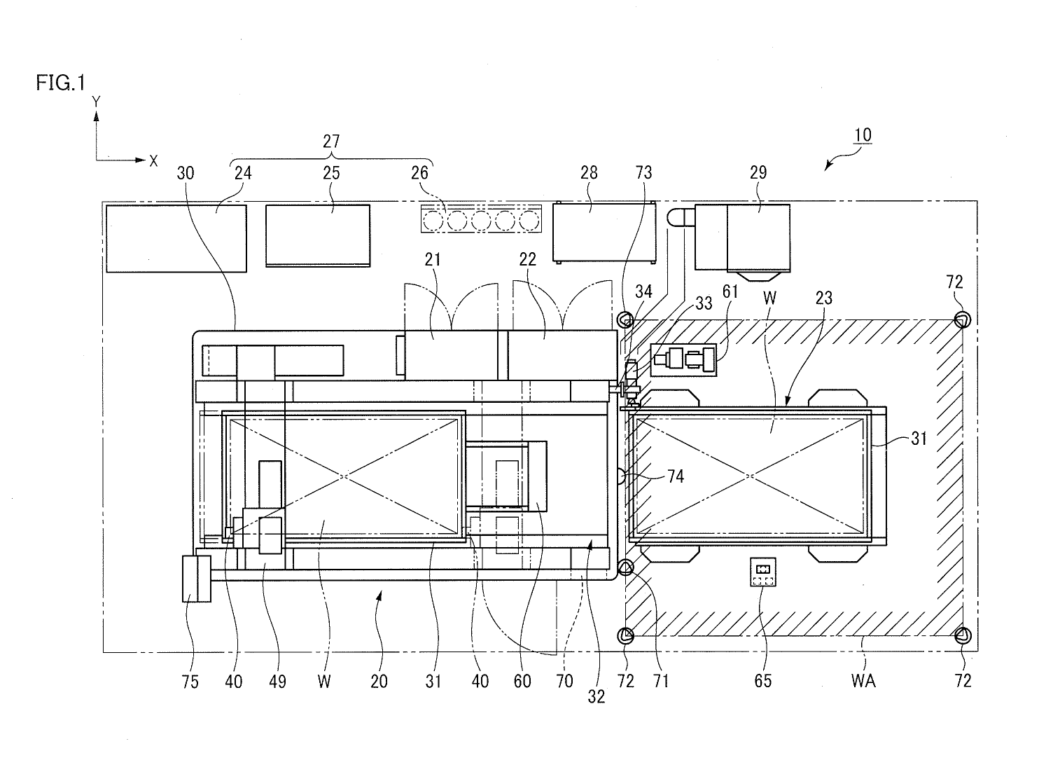

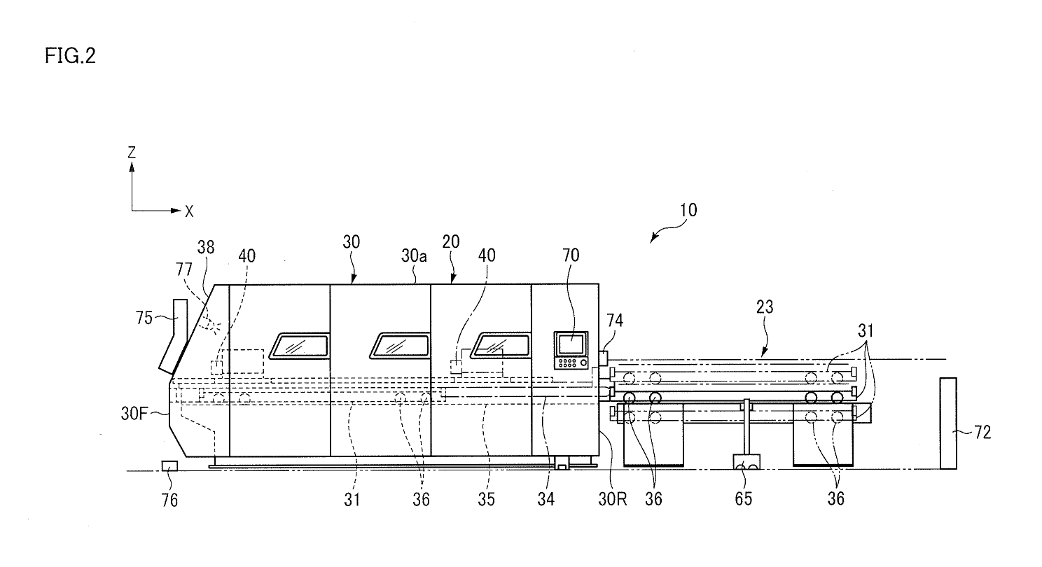

As shown in FIGS. 1 and 2, a laser processing machine 10 mainly includes a processing machine body 20, a laser oscillator 21 and a control device 22 incorporated into processing machine body 20, a pallet changer 23 disposed to be connected to processing machine body 20, an assist gas supply portion 27 including a booster compressor 24 and an air compressor 25 used to separate a nitrogen gas in the air, or nitrogen and oxygen gas cylinders 26 and the like, a chiller unit 28 for supplying cooling water that cools laser oscillator 21 and a laser processing head 40, and a dust collector 29 for removing dust and the like that occur during processing.

In the present embodiment, “frontward” refers to a direction closer to processing machine body 20 in a direction of arrangement of processing machine body 20 and pallet changer 23 (in the X direction in FIG. 1), and “rearward” refers to a direction closer to pallet changer 23 in this direction of arrangement. In addition, “leftward” and “rightward” are expressed by directions when viewing the frontward from the rearward in a direction orthogonal to the direction of arrangement (in the Y direction in FIG. 1).

Housed in a cabin 30 of processing machine body 20 are a pallet drive mechanism 32 for driving a pallet 31 in a prescribed direction, i.e., in a longitudinal direction (X direction) of cabin 30, laser processing head 40 for emitting laser beams for thermally cutting a workpiece W mounted on pallet 31, a processing head drive mechanism 49 for driving laser processing head 40, and a collection conveyor 60 for collecting scraps and the like cut during processing.

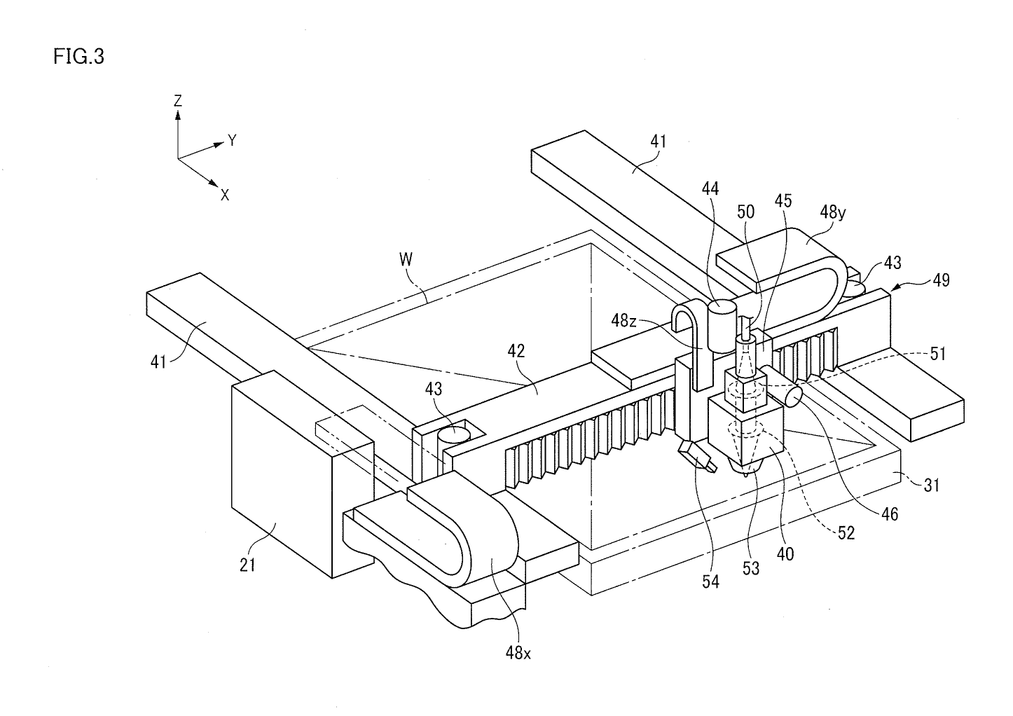

As shown in FIG. 3, processing head 40 is movable in the X direction, in a width direction (Y direction) of cabin 30, and in a vertical direction (Z direction) of cabin 30 by processing head drive mechanism 49. Specifically, a beam-like X-direction movable platform 42 is arranged to span a pair of support platforms 41 provided right and left, and this X-direction movable platform 42 is driven in the X direction by an X-axis motor 43. A Y-direction movable platform 45 that is driven by a Y-axis motor 44 and is movable in the Y direction is also disposed at X-direction movable platform 42. Y-direction movable platform 45 is driven in the Y direction by a rack and pinion mechanism for meshing a not-shown pinion fixed to a rotation shaft of Y-axis motor 44 with a not-shown rack arranged in X-direction movable platform 42. In addition, by using a rack and pinion mechanism driven by a Z-axis motor 46, processing head 40 is disposed at Y-direction movable platform 45 so as to be movable in the Z direction.

Processing head 40 shown by a solid line in FIG. 1 and a dotted line in FIG. 2 indicates a state of being located at the most frontward part in the X direction (corresponding to a processing time placement position P1 of pallet 31), and processing head 40 shown by an alternate long and short dash line in FIGS. 1 and 2 indicates a state of being located at the most rearward part in the X direction.

A fiber cable (only a tip thereof is shown) 50 extending from laser oscillator 21 is routed through an X-direction cableveyor (registered trademark) 48x and a Y-direction cableveyor (registered trademark) 48y, and is connected to processing head 40. Also arranged in processing head 40 are a collimator lens 51 for parallelizing the laser beams emitted from an emission end of fiber cable 50, and a condenser lens 52 for condensing the parallelized laser beams. Condenser lens 52 is provided such that a position thereof can be freely adjusted in the Z direction with respect to processing head 40. The known configuration of laser oscillator 21 can be applied, and thus, detailed description will not be repeated.

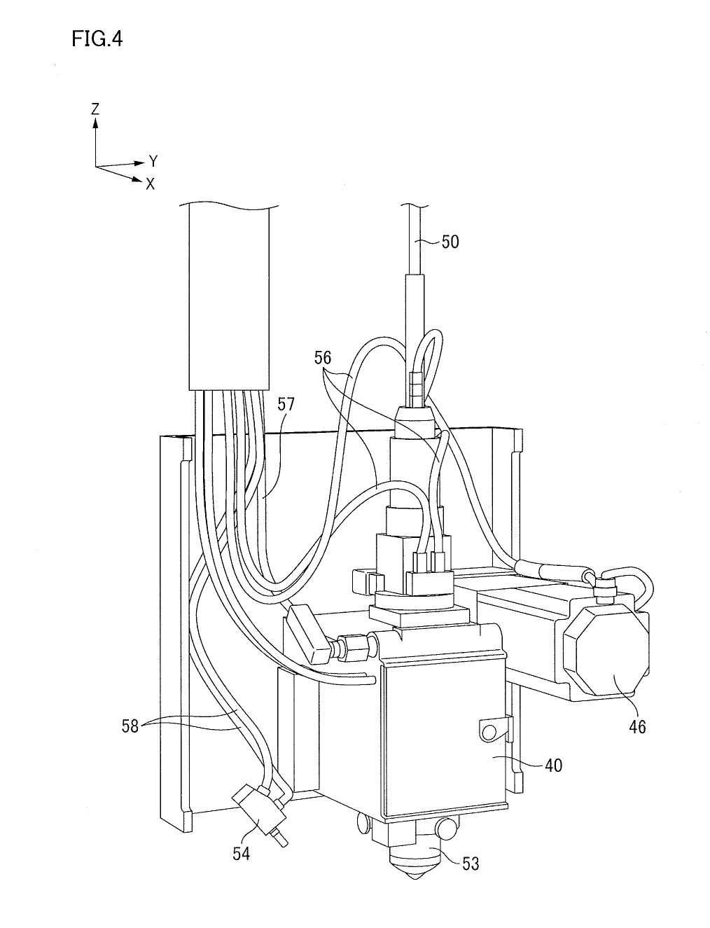

As shown in FIG. 4, a cooling pipe 56 provided from chiller unit 28 is connected around processing head 40 to cool the emission end of fiber cable 50 and the surroundings of condenser lens 52. Furthermore, provided around processing head 40 are a gas supply pipe 57 for supplying an assist gas such as a nitrogen gas or an oxygen gas from assist gas supply portion 27 into processing head 40, and another gas supply pipe 58 connected to a side nozzle 54 for spraying the assist gas such as the nitrogen gas or the oxygen gas toward the neighborhood of a laser nozzle 53 of processing head 40.

These cooling pipe 56 and gas supply pipes 57 and 58 pass through a Z-direction cableveyor (registered trademark) 48z, and then, are routed to X-direction cableveyor (registered trademark) 48x and Y-direction cableveyor (registered trademark) 48y, together with fiber cable 50, and are connected to chiller unit 28 and assist gas supply portion 27.

When laser oscillator 21 is actuated, the laser beams pass through fiber cable 50 and are parallelized by collimator lens 51. Further, the parallelized laser beams enter condenser lens 52 to be condensed, and are emitted from laser nozzle 53 to a portion of workpiece W to be processed, and processing head 40 processes workpiece W. During processing, the assist gas supplied from assist gas supply portion 27 is injected from laser nozzle 53 and side nozzle 54 toward the portion of workpiece W to be processed, such that the molten metal generated during processing is blown away.

As shown in FIGS. 1 and 2, pallet drive mechanism 32 is disposed at a position facing a right side surface of pallet 31 along the X direction, and has an endless chain 34 rotationally driven by a drive motor 33, and a rail 35 on which a plurality of rollers 36 provided on the lower surface side of pallet 31 are guided in a rolling manner and which supports pallet 31. When endless chain 34 is rotationally driven by drive motor 33, a pin (not shown) provided at endless chain 34 engages with an engagement portion (not shown) of pallet 31 and pallet 31 on rail 35 is moved in the X direction.

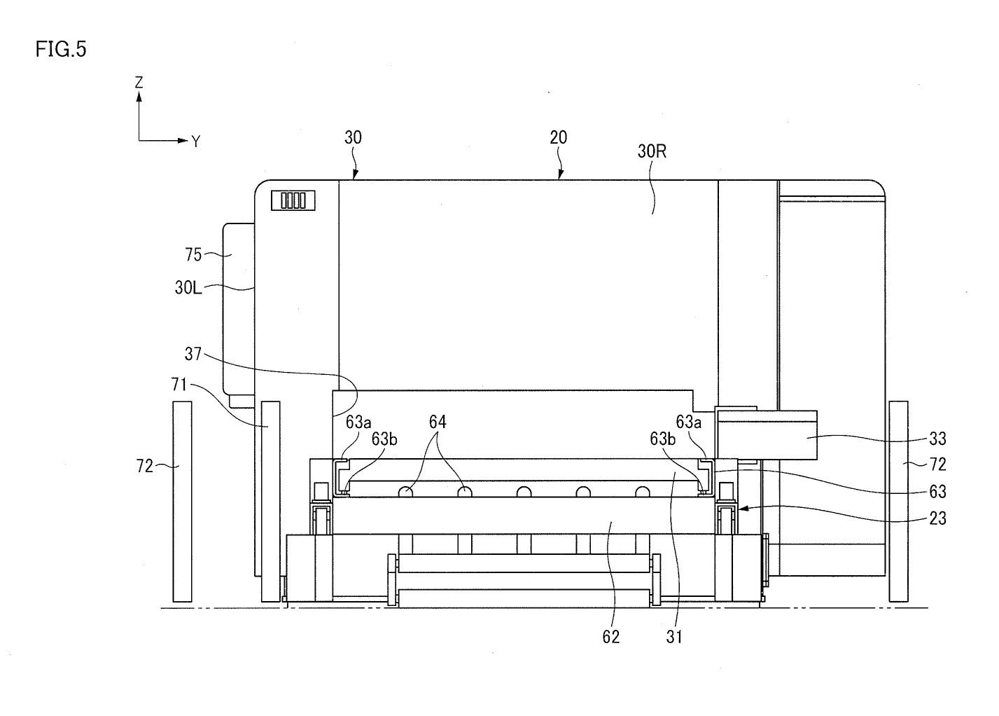

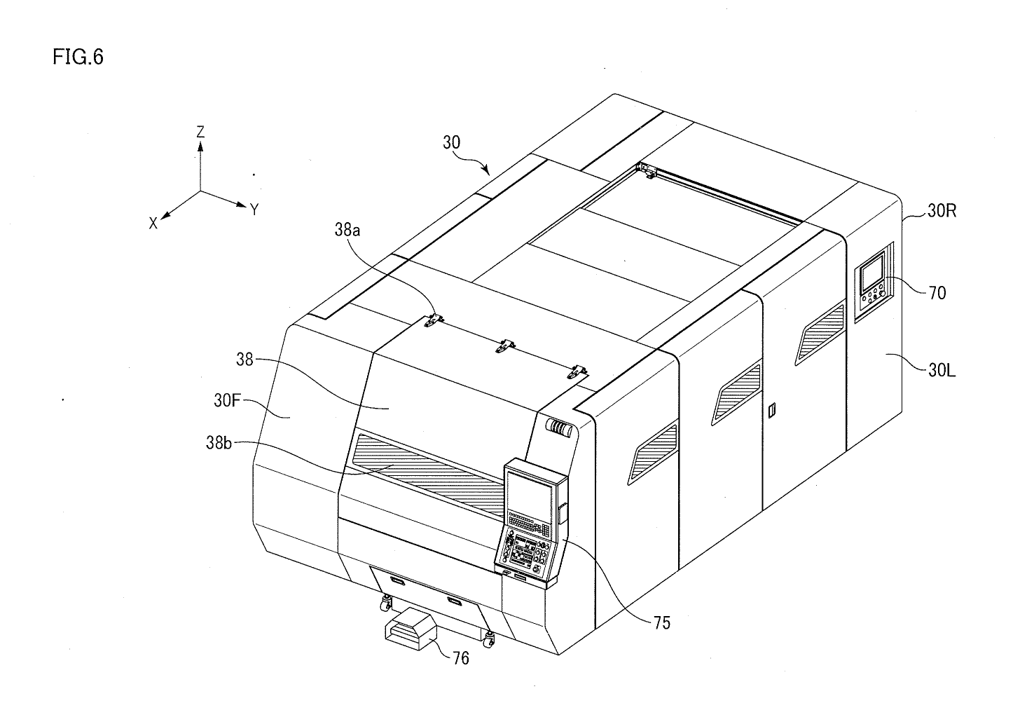

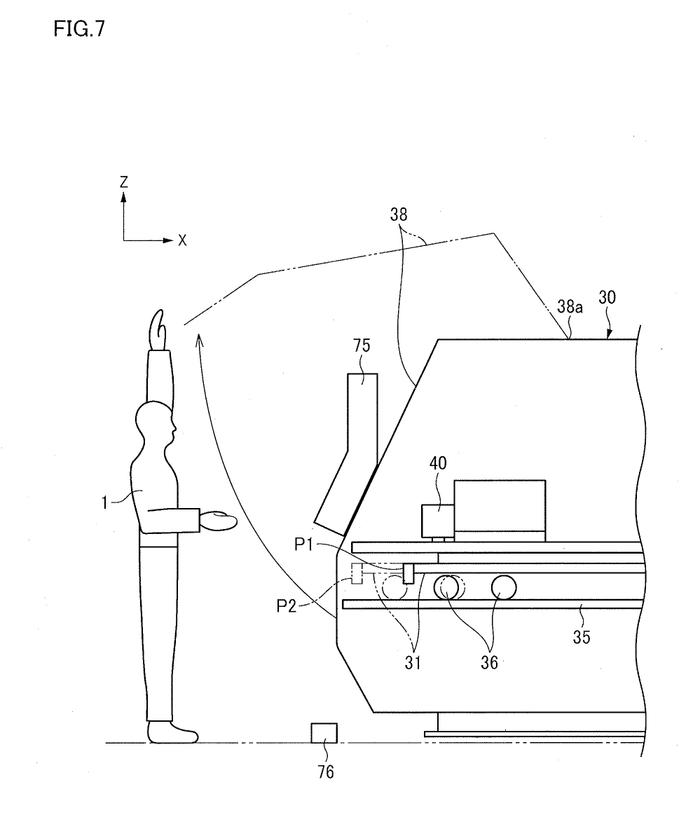

As shown in FIGS. 5 and 6, a gull wing 38 which is an open/close door is provided on a first surface (front surface) 30F of cabin 30, and on a second surface (rear surface) 30R which is the opposite side of front surface 30F, a loading/unloading port 37 formed in the shape of a horizontally long slit is provided to correspond to pallet changer 23. Gull wing 38 has a pivot point 38a provided at a position on a ceiling 30a of cabin 30 distant from front surface 30F, and thus, a forward protruding distance of gull wing 38 at the time of opening and closing is reduced (see FIG. 7).

On front surface 30F, a first control panel 75 is also arranged at a lateral part of gull wing 38. On a third surface (left side surface) 30L orthogonal to front surface 30F and rear surface 30R, a second control panel 70 is arranged closer to rear surface 30R. Furthermore, a foot switch 76 that can be foot-operated by an operator 1 is arranged at front surface 30F of cabin 30 and below gull wing 38. Foot switch 76 can be foot-operated by operator 1, and thus, even with the operator 1's hands full, gull wing 38 can be opened to perform the work.

An LED illumination 77 is provided in cabin 30 as notifying means for notifying the operator of the opening/closing operation of gull wing 38 at the time of the opening/closing operation of gull wing 38 (see FIG. 2). By causing LED illumination 77 to flash during the opening/closing operation of gull wing 38 and notifying the operator of during the operation through a window portion 38b (see FIG. 6) of gull wing 38, the opening/closing operation can be performed more safely. Instead of LED illumination 77, a not-shown beeper may be provided as the notifying means to notify the operator of the opening/closing operation by sound.

As shown in FIGS. 1, 2 and 5, pallet changer 23 is arranged to face rear surface 30R of cabin 30 having loading/unloading port 37. Pallet changer 23 has a movable frame 62 driven upwardly and downwardly by a drive mechanism 61 shown in FIG. 1, and two pallets 31 can be arranged vertically in two stages on a substantially C-shaped rail 63 provided at right and left lateral parts of movable frame 62.

Upper pallet 31 is placed on an upper rail surface 63a of C-shaped rail 63, and lower pallet 31 is placed on a lower rail surface 63b of C-shaped rail 63. A height of pallets 31 arranged in two stages on C-shaped rail 63 is adjustable such that when movable frame 62 is driven upwardly and downwardly by drive mechanism 61, pallets 31 on substantially C-shaped rail 63 can move upwardly and downwardly to come level with rail 35 disposed in cabin 30. Therefore, pallet 31 located at the same height as that of rail 35 can be loaded/unloaded between pallet changer 23 and the inside of cabin 30 through loading/unloading port 37.

A free bearing 64 for moving workpiece W on pallet 31 to cause workpiece W to hit a reference of pallet 31 is provided below movable frame 62 such that free bearing 64 can be moved up and down (see FIG. 5).

In FIGS. 1 and 2, a reference character 65 represents another foot switch for actuating drive mechanism 61 that drives free bearing 64 upwardly and downwardly.

As shown in FIG. 1, a sensor including a photo transmitter 71, reflectors 72 and a photo receiver 73 is arranged at each corner of a working area WA enclosing pallet changer 23, and the light emitted from photo transmitter 71 is reflected by three reflectors 72 and received by photo receiver 73, thereby monitoring entrance and exit of operator 1 into and from working area WA. An area sensor 74 is also disposed on rear surface 30R of cabin 30 to detect whether operator 1 is in working area WA or not. When the sensor including photo transmitter 71, reflectors 72 and photo receiver 73 or area sensor 74 is actuated, it is determined that operator 1 is in working area WA, and the actuation of laser processing machine 10 is prohibited, and thus, the safety of operator 1 is ensured.

Next, the effect of the present embodiment will be described. Basically, laser processing machine 10 according to the present embodiment performs processing of a large-lot product on the pallet changer 23 side and performs processing of a small-lot product on the gull wing 38 side.

First, processing of a large-lot product will be schematically described. As shown in FIG. 1, at the time of processing of a large-lot product, workpiece W is placed and positioned on pallet 31 in pallet changer 23, and thereafter, second control panel 70 is operated and pallet drive mechanism 32 is driven to load pallet 31 into cabin 30 through loading/unloading port 37, for example. When pallet 31 moves to processing time placement position P1, the laser beams from laser oscillator 21 are condensed by condenser lens 52 and processing head 40 is moved in the X, Y and Z directions, such that the portion of workpiece W to be processed is irradiated with the laser beams and is processed.

During this processing, workpiece W is placed on next pallet 31 and preparation for processing of the next lot is made in pallet changer 23. When the preceding processing ends, pallet 31 having the processed product placed thereon is unloaded to pallet changer 23 through loading/unloading port 37 by pallet drive mechanism 32. Then, next pallet 31 in which the preparation for processing has ended is loaded into cabin 30 through loading/unloading port 37 and laser processing is performed similarly.

On the other hand, at the time of processing of a small-lot product, foot switch 76 or first control panel 75 is operated to open gull wing 38. When gull wing 38 is opened, pallet drive mechanism 32 is actuated in response thereto and pallet 31 located at processing time placement position P1 moves to the side closer to gull wing 38 than processing time placement position P1, i.e., a pallet drawn-out position P2 closer to operator 1 (see FIG. 7). As a result, pallet 31 moves near operator 1, and thus, the work becomes easy.

When operator 1 places workpiece W on pallet 31 located at pallet drawn-out position P2 and thereafter closes gull wing 38, pallet 31 moves to processing time placement position P1 in response to this closing operation and processing by the laser beams is performed. In view of the safety of operator 1, the closing operation of gull wing 38 is performed in response to only operation of first control panel 75. Then, when gull wing 38 is opened after the end of processing, pallet 31 again moves to pallet drawn-out position P2 close to operator 1. Therefore, operator 1 can easily take out the processed product, without taking an uncomfortable posture such as a waist-bent posture.

As described above, the work is performed on the pallet changer 23 side in the case of a large-lot product and the work is performed on the gull wing 38 side in the case of a small-lot product. Therefore, at the time of processing of a large-lot product, processing by the laser beams and the preparation work including take-out of the product and placement of workpiece W on pallet 31 can be simultaneously performed in parallel. At the time of processing of a small-lot product, gull wing 38 can be opened and closed to perform processing, without performing the pallet replacement work in pallet changer 23. Therefore, the work can be performed in a short time and the product can be manufactured efficiently.

### EXAMPLE

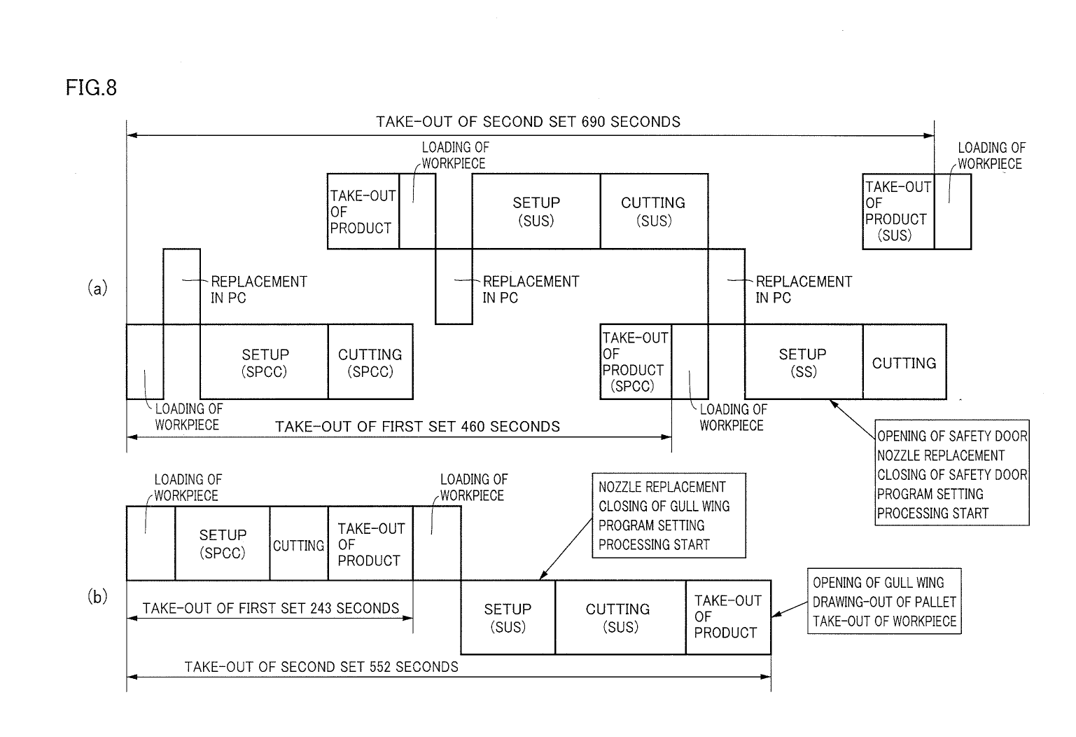

As an example of processing using laser processing machine 10 according to the present embodiment, comparison in terms of work time between processing using pallet changer 23 and processing using gull wing 38 when a SPCC plate having a plate thickness of 1.6 mm, a SUS plate having a plate thickness of 3 mm, and a SS (soft steel) plate having a plate thickness of 6 mm are continuously processed in this order will be described with reference to FIG. 8.

As shown in FIG. 8(a), in the work using pallet changer 23, cutting processing of the SPCC plate is performed after loading of the SPCC, replacement in pallet changer 23 and setup are performed. Simultaneously with this cutting processing, the preparation work for the SUS plate (loading of the SUS plate, replacement in pallet changer 23 and setup) is performed in pallet changer 23, subsequently to take-out of the preceding product. During this preparation work for the SUS plate, pallet 31 of the SPCC plate cannot be unloaded even if processing of the SPCC plate has ended. Therefore, the pallet of the SPCC plate is unloaded after the end of the preparation work for pallet 31 of the SUS plate. Therefore, take-out of the processed SPCC product, which is the first set, is performed 460 seconds after the start of processing. Similarly, take-out of the SUS product, which is the second set, is performed 690 seconds after the start of processing.

Setup in this case includes the opening operation of a safety door provided at loading/unloading port 37, nozzle replacement, the closing operation of the safety door, program setting, and the processing start time.

On the other hand, as shown in FIG. 8(b), in the work using gull wing 38, loading of the SPCC plate from gull wing 38 and setup are performed, and after the end of cutting processing, gull wing 38 can be opened immediately to perform the take-out work for the SPCC product. Subsequently to the take-out work for the SPCC product, loading of the SUS plate, setup, cutting processing, and the take-out work for the SUS product are performed. Therefore, take-out of the processed SPCC product, which is the first set, is performed 243 seconds after the start of processing. Take-out of the SUS product, which is the second set, is performed 552 seconds after the start of processing. Therefore, the processing time is significantly reduced as compared with the case of using pallet changer 23.

Setup in this case includes nozzle replacement, the closing operation of gull wing 38, program setting, and the processing start time. Take-out of the product includes the opening operation of gull wing 38, drawing-out of the pallet and take-out of the workpiece.

As described above, according to laser processing machine 10 of the present embodiment, gull wing 38 is provided on front surface 30F of cabin 30 that houses pallet drive mechanism 32 and processing head 40, and loading/unloading port 37 is provided on rear surface 30R of cabin 30. Therefore, at the time of processing of a large-lot product, pallet 31 having workpiece W placed thereon is loaded and unloaded through loading/unloading port 37, and at the time of processing of a small-lot product, workpiece W is loaded and unloaded from gull wing 38. Thus, the loading/unloading work is performed in accordance with the lot size. As a result, efficient processing can be achieved.

In addition, pallet drive mechanism 32 can drive pallet 31 to pallet drawn-out position P2 that is closer to the gull wing 38 side than processing time placement position P1. Therefore, when a small-lot product is loaded and unloaded from gull wing 38, the work can be easily performed in a comfortable posture and a burden on operator 1 can be reduced.

In addition, pallet drive mechanism 32 is actuated in response to opening and closing of gull wing 38. When gull wing 38 is opened, pallet 31 automatically moves from processing time placement position P1 to pallet drawn-out position P2. When gull wing 38 is closed, pallet 31 automatically moves from pallet drawn-out position P2 to processing time placement position P1. Therefore, the loading/unloading work from gull wing 38 can be easily performed.

Furthermore, cabin 30 is provided with first control panel 75 near gull wing 38 and second control panel 70 near loading/unloading port 37. Therefore, in accordance with whether the small-lot work on the gull wing 38 side or the large-lot work on the loading/unloading port 37 side is performed, closer control panel 75 or 70 can be used. Thus, a movement distance of operator 1 can be minimized and efficient processing can be achieved.

In addition, foot switch 76 that can be foot-operated by operator 1 when gull wing 38 is opened is provided below gull wing 38. Therefore, even with the operator l′s hands full, gull wing 38 can be opened to perform the work.

Furthermore, gull wing 38 is a gull wing that upwardly pivots about pivot point 38a provided on ceiling 30a of cabin 30. Therefore, an amount of forward protrusion along the open/close door movement path when opening and closing gull wing 38 is reduced, and gull wing 38 can be opened and closed safely. In addition, a space for placing laser processing machine 10 can be reduced.

In addition, at the time of the opening/closing operation of gull wing 38, the operator is notified of this operation by flashing of the LED illumination or the beeper. Therefore, the opening/closing operation of gull wing 38 can be performed more safely.

The present invention is not limited to the aforementioned embodiment, and variation, modification or the like is possible as appropriate.

The present invention is not limited to the fiber laser processing machine according to the present embodiment and is applicable to any laser processing machine. In addition, the present invention is not limited to the laser processing machine and is applicable to a thermal cutting machine such as a plasma processing machine and a gas cutting machine.

### REFERENCE SIGNS LIST

1 operator; 10 laser processing machine (thermal cutting machine); 30 cabin; 30F front surface (first surface); 30R rear surface (second surface); 30L left side surface (third surface); 30a ceiling; 31 pallet; 32 pallet drive mechanism; 37 loading/unloading port; 38 gull wing (open/close door); 38a pivot point; 40 laser processing head; 70 second control panel; 75 first control panel; 76 foot switch; P1 processing time placement position; P2 pallet drawn-out position; W workpiece.

1. A thermal cutting machine that thermally cuts a workpiece on a pallet, comprising:
a processing head for allowing a workpiece to generate heat;
a cabin for housing said processing head;
a pallet on which said workpiece is placed; and
a pallet drive mechanism for driving said pallet in a prescribed direction, wherein an open/close door is provided on a first surface of said cabin, and a loading/unloading port for loading said pallet into said cabin or unloading said pallet from said cabin is provided on a second surface of said cabin located on an opposite side of said first surface in said prescribed direction.

2. The thermal cutting machine according to claim 1, wherein
said pallet drive mechanism can drive said pallet to a pallet drawn-out position that is closer to said first surface side than a processing time placement position of said pallet at the time of processing.

3. The thermal cutting machine according to claim 2, wherein
said pallet drive mechanism can drive said pallet in response to opening and closing of said open/close door, and
said pallet drive mechanism moves said pallet to said pallet drawn-out position when said open/close door is opened, and moves said pallet to said processing time placement position when said open/close door is closed.

4. The thermal cutting machine according to claim 1, wherein
said cabin is provided with a second control panel arranged on a third surface orthogonal to said first surface and said second surface and arranged at a position closer to said second surface than said first surface, and a first control panel arranged on said first surface and arranged closer to said third surface side than said open/close door.

5. The thermal cutting machine according to claim 1, further comprising
a foot switch that is arranged below said open/close door and can be foot-operated by an operator, wherein
said foot switch is operated at the time of an opening operation of said open/close door.

6. The thermal cutting machine according to claim 1, wherein
said open/close door is a gull wing that is supported by a supporting portion provided at a position on a ceiling of said cabin distant from said first surface and upwardly pivots about said supporting portion.

7. The thermal cutting machine according to claim 1, further comprising
notifying means for, at the time of at least one of an opening operation and a closing operation of said open/close door, notifying an operator of the operation by light or sound.
